(19) United States
(12) Patent Application Publication
(10) Pub. No.: US 2007/0272499 A1
(43) Pub. Date: Nov. 29, 2007

(54) SAFETY BRAKING ASSEMBLY FOR A BICYCLE

(76) Inventor: Wen Liang SHIAO, Taichung (TW)

Correspondence Address: PATENTTM.US, P. O. BOX 82788, PORTLAND, OR, 97282-0788, US

(21) Appl. No.: 11/750,751

(22) Filed: May 18, 2007

(30) Foreign Application Priority Data
May 26, 2006 (CN) 200620112278.9

(51) Int. Cl. B62L 3/00

(52) U.S. Cl. 188/24.11

(57) ABSTRACT

A safety braking assembly for a bicycle has a cylinder box, a pair of upper protecting pipes, a pair of lower protecting pipes, a front brake cable, a rear brake cable, a lower fixed block and an upper fixed block. The cylinder box has a mounting sleeve, an upper cover and a lower cover. The covers are mounted over two ends of the mounting sleeve. The upper protecting pipes are connected to the upper cover. The lower protecting pipes are connected to the lower cover. The brake cables are extended through the cylinder box and extend out the upper protecting pipes and the lower protecting pipes. The upper fixed block is connected to the rear brake cable and can slide relative to the front brake cable. The lower fixed block is connected to the front brake cable and can push against the upper fixed block.

### BACKGROUND OF THE INVENTION

1. Field of the Invention

The present invention relates to a safety braking assembly and more particularly to a safety braking assembly that can provide a security braking efficiency for a bicycle.

2. Description of Related Art

A conventional bicycle brake system is mounted on a bicycle having a front wheel, a rear wheel and two handlebars, and has two brakes and two cables to provide a braking effect to the bicycle. The brakes are respectively mounted on the bicycle, correspond respectively to the front wheel and the rear wheel and include a front brake and a rear brake. Each cable is connected between a brake lever mounted on one of the handlebars and one of the brakes.

A person can pull or press one of the brake levers to actuate the rear brake or the front brake with a corresponding cable to make the rear wheel or the front wheel to slow down or stop. However, it is unavoidable that some situations may happened in suddenly while in riding and cause the person applying only for the front brake but keeping the rear brake free due to nervousness. However, this results in an incorrect applying of brake, and the person easily tumbles from the bicycle and gets in injury.

A safety braking assembly for a bicycle in accordance with the present invention mitigates or obviates the aforementioned problems.

### SUMMARY OF THE INVENTION

The main objective of the present invention is to provide a safety braking assembly and more particularly to a safety braking assembly that can provide a security braking efficiency for a bicycle.

The safety braking assembly for a bicycle has a cylinder box, a pair of upper protecting pipes, a pair of lower protecting pipes, a front brake cable, a rear brake cable, a lower fixed block and an upper fixed block. The cylinder box has a mounting sleeve, an upper cover and a lower cover. The covers are mounted around the mounting sleeve. The upper protecting pipes are connected to the upper cover. The lower protecting pipes are connected to the lower cover. The brake cables are extended through the cylinder box and extend out the upper protecting pipes and the lower protecting pipes. The upper fixed block is connected to the rear brake cable and can slide relative to the front brake cable. The lower fixed block is connected to the front brake cable and can push against the upper fixed block while sliding up relative to the rear brake cable.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a safety braking assembly in accordance with the present invention on a bicycle;

FIG. 2 is an enlarged perspective view of the safety braking assembly in FIG. 1;

FIG. 3 is an exploded perspective view of the safety braking assembly in FIG. 1;

FIG. 4 is a front view in partial section of the safety braking assembly in FIG. 1;

FIG. 5 is an operational front view of the safety braking assembly in FIG. 4 when the rear brake cable is pulled; and

FIG. 6 is another operational front view of the safety braking assembly in FIG. 4 when the front brake cable is pulled.

### DETAILED DESCRIPTION OF THE PREFERRED EMBODIMENT

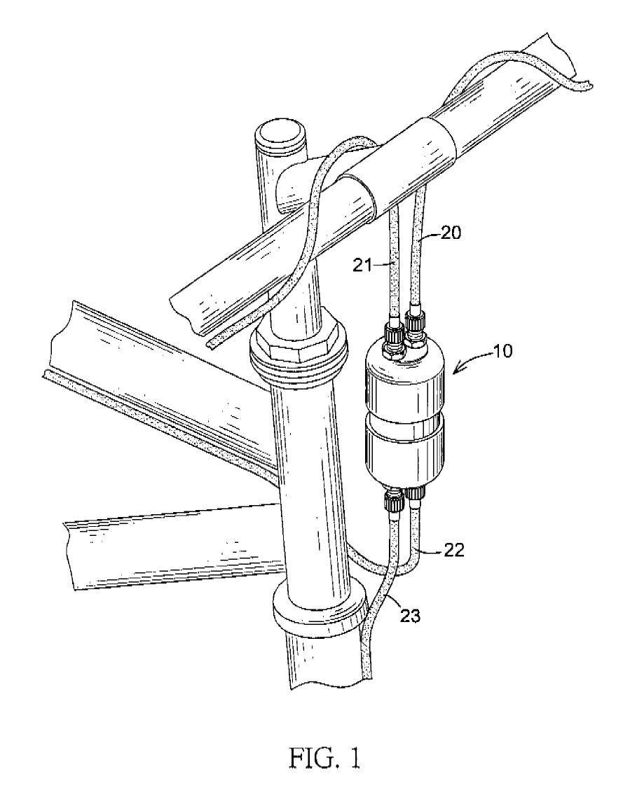

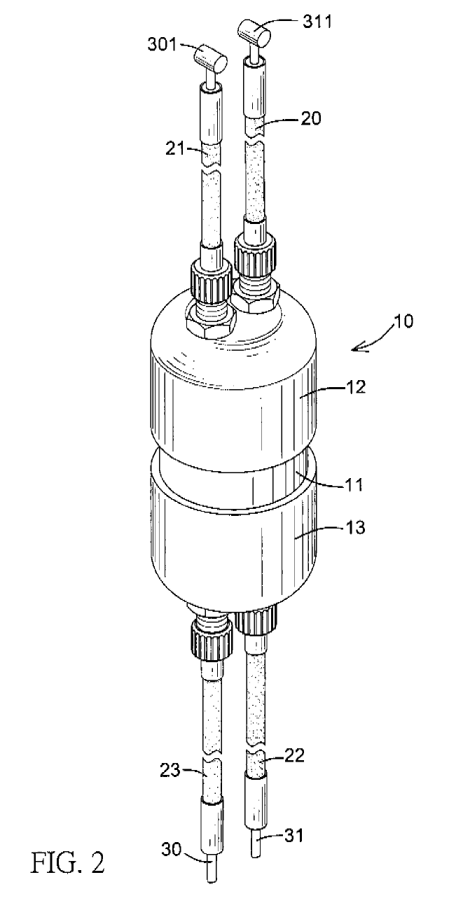

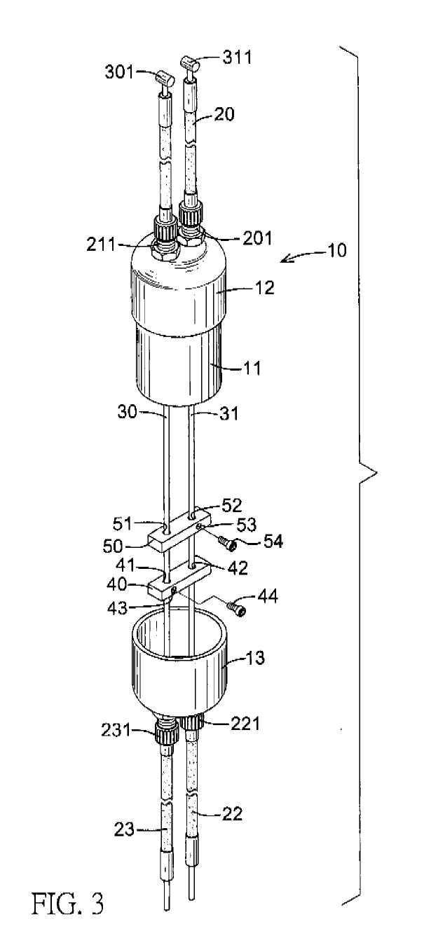

With reference to FIGS. 1 to 4, a safety braking assembly in accordance with the present invention is used on a bicycle having a front brake, a rear brake, a right handlebar, a left handlebar, a front wheel and a rear wheel, and the safety braking assembly comprises a cylinder box (10), a pair of upper protecting pipes (20, 21), a pair of lower protecting pipes (22, 23), two brake cables (30, 31) and two fixed blocks (50, 40).

The cylinder box (10) is hollow and has a mounting sleeve (11), an upper cover (12) and a lower cover (13). The mounting sleeve (11) is tubular and has a top and a bottom. The upper cover (12) is mounted securely over the top of the mounting tube (11) and has a closed top end and two upper mounting holes (121, 122). The upper mounting holes (121, 122) are formed through the closed top end of the upper cover (12) and communicate with the mounting sleeve (11). The lower cover (13) is mounted securely over the bottom of the mounting sleeve (11) and has a closed bottom end and two lower mounting holes (131, 132). The lower mounting holes (131, 132) are formed through the closed bottom end of the lower cover (13) and align respectively with the upper mounting holes (121, 122) in the upper cover (12).

The upper protecting pipes (20, 21) are connected securely to the upper cover (12) and include a rear upper protecting pipe (20) and a front upper protecting pipe (21), and each upper protecting pipe (20, 21) has a mounting end, a lever end and a jointer (201, 211). The jointers (201, 211) respectively are mounted on and protrude from the mounting ends of the upper protecting pipes (20, 21), and are connected securely to the upper mounting holes (121, 122) in the upper cover (12). The lever ends of the upper protecting pipes (20, 21) are connected to brake levers mounted on the handlebars in the bicycle.

The lower protecting pipes (22, 23) are connected securely to the lower cover (13) and include a rear lower protecting pipe (22) and a front lower protecting pipe (23), and each lower protecting pipe (22, 23) has a mounting end, a brake end and a jointer (221, 231). The jointers (221, 231) respectively are mounted on and protrude from the mounting ends of the lower protecting pipes (22, 23), and are connected securely to the lower mounting holes (131, 132) in the lower cover (13). The brake ends of the lower protecting pipes (22, 23) are connected respectively to the brakes in the bicycle.

The brake cables (30, 31) extend through the cylinder box (10), extend out of the upper protecting pipes (20, 21) and the lower protecting pipes (22, 23) and include a front brake cable (30) and a rear brake cable (31).

The front brake cable (30) extends through the cylinder box (10), extends out of the front upper protecting pipe (21) and the front lower protecting pipe (23) and has a lever end, a brake end and a connecting stub (301). The lever end of the front brake cable (30) extends out of the lever end of the front upper protecting pipe (21) through the corresponding upper mounting hole (122) in the upper cover (12). The brake end of the front brake cable (30) extends out of the brake end of the front lower protecting pipe (23) through the corresponding lower mounting hole (132) in the lower cover (13), and is connected to the front brake in the bicycle. The connecting stub (301) is formed on the lever end of the front brake cable (30) and is connected to the brake lever mounted on the right handlebar of the bicycle.

The rear brake cable (31) extends through the cylinder box (10) and extends out of the rear upper protecting pipe (20) and the rear lower protecting pipe (22) and has a lever end, a brake end and a connecting stub (311). The lever end of the rear brake cable (31) extends of out the lever end of the rear upper protecting pipe (20) through the corresponding upper mounting hole (121) in the upper cover (12). The brake end of the rear brake cable (31) extends out of the brake end of the rear lower protecting pipe (22) through the corresponding lower mounting hole (131) in the lower cover (13), and is connected to the rear brake in the bicycle. The connecting stub (311) is formed on the lever end of the rear brake cable (31) and is connected to the brake lever mounted on the left handlebar in the bicycle.

The fixed blocks (50, 40) may be rectangular, are respectively connected to the brake cables (30, 31) at positions in the mounting sleeve (11) and include a upper fixed block (50) and a lower fixed block (40).

The upper fixed block (50) is connected securely to the rear brake cable (31), is slidable relative to the front brake cable (30) and has a top face, a bottom face, a front, a first through hole (51), a second through hole (52), a connecting hole (53) and a set screw (54). The first through hole (51) is formed through the upper fixed block (50) from the top face to the bottom face, and the front brake cable (30) extends slidably through the first through hole (51) in the upper fixed block (50). The second through hole (52) is formed through the upper fixed block (50) from the top face to the bottom face and the rear brake cable (31) extends through the second through hole (52) in the upper fixed block (50). The connecting hole (53) is threaded, is formed through the front of the upper fixed block (50) and communicates with the second through hole (52). The set screw (54) is screwed into the connecting hole (53) and presses against the rear brake cable (31) in the second through hole (52) to securely hold the upper fixed block (50) on the rear brake cable (31).

The lower fixed block (40) is connected securely to the front brake cable (30) at a position below the upper fixed block (50), is slidable relative to the rear brake cable (31) and selectively pushes against the upper fixed block (50) while sliding up relative to the rear brake cable (31). The lower fixed block (40) has a top face, a bottom face, a front, a first through hole (41), a second through hole (42), a connecting hole (43) and a set screw (44). The first through hole (41) is formed through the lower fixed block (40) from the top face to the bottom face, and the front brake cable (30) extends through the first through hole in the lower fixed block (40). The second through hole (42) is formed through the lower fixed block (40) from the top face to the bottom face, and the rear brake cable (31) extends slidably through the second through hole (42) in the lower fixed block (40). The connecting hole (43) is threaded, is formed through the front of the lower fixed block (40) and communicates with the first through hole (41). The set screw (44) is screwed into the connecting hole (43) and presses against the front brake cable (30) in the first through hole (41) to securely hold the lower fixed block (40) on the front brake cable (30).

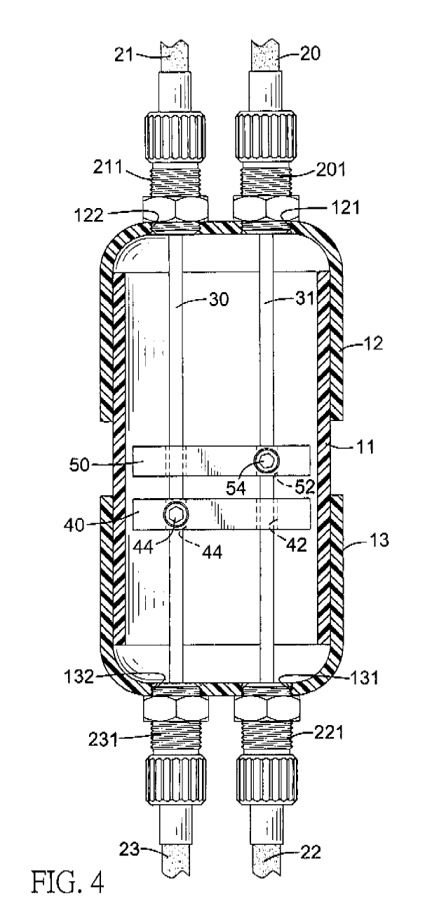

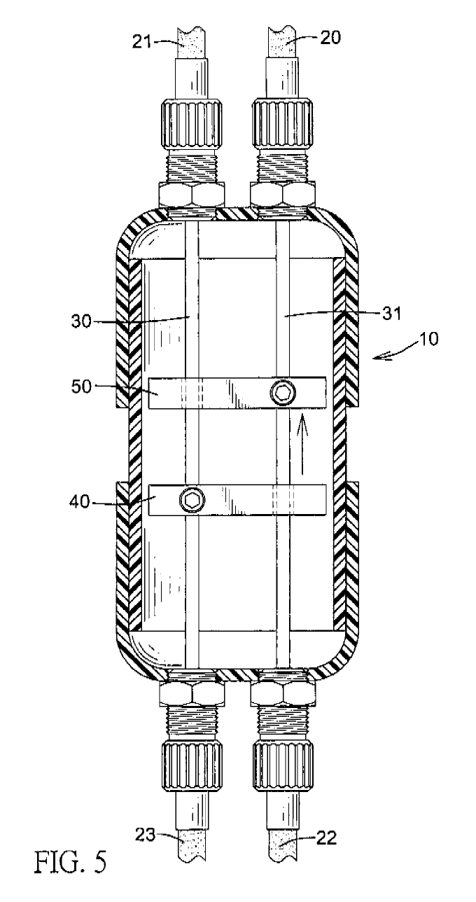

With further reference to FIGS. 4 and 5, when a person pulls the brake lever on the left handlebar to actuate the rear brake with the rear brake cable (31), the upper fixed block (50) will move up with the rear brake cable (31) relative to the front brake cable (30) and the front brake cable (30) is kept free from moving.

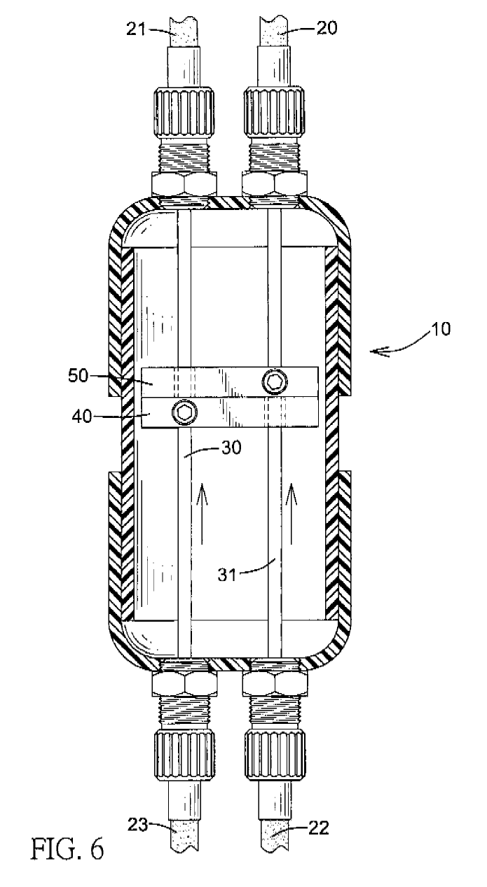

With further reference to FIG. 6, when a person pulls the brake lever on the right handlebar to actuate the front brake with the front brake cable (30), the lower fixed block (40) will move up with the front brake cable (30) and push against the upper fixed block (50) to move the rear brake cable (31). When the upper fixed block (50) is moved up, the rear brake cable (31) will actuate the rear brake to provide a braking effect to the rear wheel.

Accordingly, when some situation happened in suddenly, the rear brake is certainly actuated even when only the brake lever connected to the front brake is pulled. Therefore, the safety braking assembly in accordance with the present invention provides a secure braking efficiency to the bicycle and can prevent riders from tumbling and getting in injury.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the fill extent indicated by the broad general meaning of the terms in which the appended claims are expressed.

What is claimed is:

1. A safety braking assembly for a bicycle having
a cylinder box being hollow and having
a mounting sleeve being tubular and having
a top; and
a bottom;
an upper cover being mounted securely over the top of the mounting sleeve and having
a closed top end; and
two upper mounting holes being formed through the closed top end of the upper cover and communicating with the mounting sleeve; and
a lower cover being mounted securely over the bottom of the mounting sleeve and having
a closed bottom end; and
two lower mounting holes being formed through the closed bottom end of the lower cover and aligning respectively with the upper mounting holes in the upper cover;
a pair of upper protecting pipes being connected securely to the upper cover and including a rear upper protecting pipe and a front upper protecting pipe, and each upper protecting pipe having
a mounting end;
a lever end; and
a jointer being mounted on the mounting end of the upper protecting pipe, and being connected securely to one of the upper mounting holes in the upper cover;
a pair of lower protecting pipes being connected securely to the lower cover and including a rear lower protecting pipe and a front lower protecting pipe, and each lower protecting pipe having
a mounting end;
a brake end; and
a jointer being mounted on the mounting end of the lower protecting pipe, and being connected securely to one of the lower mounting holes in the lower cover;
a front brake cable being extended through the cylinder box, extending out of the front upper protecting pipe and the front lower protecting pipe and having
a lever end extending out of the lever end of the front upper protecting pipe through a corresponding upper mounting hole in the upper cover;
a brake end extending out of the brake end of the front lower protecting pipe through a corresponding lower mounting hole in the lower cover; and
a connecting stub being formed on the lever end of the front brake cable;
a rear brake cable being extended through the cylinder box, extending out of the rear upper protecting pipe and the rear lower protecting pipe and having
a lever end extending out of the lever end of the rear upper protecting pipe through a corresponding upper mounting hole in the upper cover;
a brake end extending out of the brake end of the rear lower protecting pipe through a corresponding lower mounting hole in the lower cover; and
a connecting stub being formed on the lever end of the rear brake cable;
an upper fixed block being connected securely to the rear brake cable and being slidable relative to the front brake cable; and
a lower fixed block being connected securely to the front brake cable at a position below the upper fixed blocks being slidable relative to the rear brake cable and selectively pushing against the upper fixed block while sliding up relative to the rear brake cable.

2. The safety braking assembly as claimed in claim 1, wherein the upper fixed block is rectangular and has
a top face;
a bottom face;
a front;
a first through hole being formed through the upper fixed block from the top face to the bottom face, and through which the front brake cable slidably extends;
a second through hole being formed through the upper fixed block from the top face to the bottom face, and through which the rear brake cable extends;
a connecting hole being threaded, being formed through the front of the upper fixed block and communicating with the second through hole; and
a set screw being screwed into the connecting hole and pressing against the rear brake cable in the second through hole.

3. The safety braking assembly as claimed in claim 2, wherein the lower fixed block is rectangular and has
a top face;
a bottom face;
a front;
a first through hole being formed through the lower fixed block from the top face to the bottom face, and through which the front brake cable extends;
a second through hole being formed through the lower fixed block from the top face to the bottom face, and through which the rear brake cable slidably extends;
a connecting hole being threaded, being formed through the front of the lower fixed block and communicating with the first through hole; and
a set screw being screwed into the connecting hole and pressing against the front brake cable in the first through hole.
